(19) United States
(12) Patent Application Publication
(10) Pub. No.: US 2022/0215143 A1
(43) Pub. Date: Jul. 7, 2022

(54) MACHINE LEARNING BASED FASTENER DESIGN

(71) Applicant: The Boeing Company, Chicago, IL (US)

(72) Inventor: Omid B. Nakhjavani, Tukwila, WA (US)

(73) Assignee: The Boeing Company, Chicago, IL (US)

(21) Appl. No.: 17/541,137

(22) Filed: Dec. 2, 2021

Related U.S. Application Data
(60) Provisional application No. 63/134,121, filed on Jan. 5, 2021.

(51) Int. Cl. G06F 30/27; G06F 30/17; G06T 5/50

(52) U.S. Cl. CPC G06F 30/27; G06F 2111/20; G06T 5/50; G06F 30/17

(57) ABSTRACT

A method includes obtaining an initial set of fastener parameter values for a fastener, executing a neural network model using features extracted at least from the initial set of fastener parameter values to query a fastener description repository, obtaining, from the fastener description repository, a set of possible matching fasteners, and presenting a matching fastener when the matching fastener is in the set of possible matching fasteners.

### RELATED APPLICATIONS

This application claims priority to U.S. Provisional Patent Application No. 63/134,121, filed Jan. 5, 2021, the contents of which are hereby incorporated by reference in their entirety.

### FIELD

Embodiments of the technology are directed to computer implemented design of hardware fasteners.

### BACKGROUND

Fasteners account for a significant amount of parts in aircrafts, space shuttles, automobiles, buildings, electronics, appliances, transportation and construction equipment, along with a variety of other uses. Generally, for a particular task, the fastener is selected by a human from a catalog of fasteners. If an appropriate fastener, within a degree of tolerance, does not exist, the human may design a new fastener. One method of design is using a computer aided design (CAD) program. Using CAD, the human specifies all characteristics (e.g., from exact geometry to materials) of the fastener, and the CAD program displays the human design in a virtual three dimensional environment. The CAD program may further provide an interface by which the human may rotate or otherwise interact with the fastener in the virtual three dimensional environment. By creating the virtual environment by which a human may specify all characteristics of the fastener, the CAD program aids the human to generating a human design of the fastener.

The fastener directly affects strength characteristics and weight of structural assemblies. As industry evolves to incorporate newer, more exotic materials, fasteners continue to figure prominently in the manufacturing and assembly processes. Fasteners play a critical role in defining the longevity, structural integrity, and design philosophy of most metallic and composite structures.

### SUMMARY

In general, in one aspect, one or more embodiments relate to a method that includes obtaining an initial set of fastener parameter values for a fastener, executing a neural network model using features extracted at least from the initial set of fastener parameter values to query a fastener description repository, obtaining, from the fastener description repository, a set of possible matching fasteners, and presenting a matching fastener when the matching fastener is in the set of possible matching fasteners.

In general, in one aspect, one or more embodiments relate to a system that includes a fastener description repository including fastener descriptions and a computer processor configured to perform operations. The operations include obtaining an initial set of fastener parameter values for a fastener, executing a neural network model using features extracted at least from the initial set of fastener parameter values to query the fastener description repository, obtaining, from the fastener description repository, a set of possible matching fasteners, and presenting a matching fastener when the matching fastener is in the set of possible matching fasteners.

In general, in one aspect, one or more embodiments relate to a non-transitory computer readable medium that includes computer readable program code for causing a computer system to perform operations. The operations include obtaining an initial set of fastener parameter values for a fastener, executing a neural network model using features extracted at least from the initial set of fastener parameter values to query a fastener description repository, obtaining, from the fastener description repository, a set of possible matching fasteners, and presenting a matching fastener when the matching fastener is in the set of possible matching fasteners.

Other aspects of the technology will be apparent from the following description and the appended claims.

### BRIEF DESCRIPTION OF DRAWINGS

FIG. 1 shows a diagram of a system in accordance with one or more embodiments.

FIG. 2 shows a flowchart in accordance with one or more embodiments.

FIG. 3 shows a flow diagram in accordance with one or more embodiments.

FIG. 4 shows an example of combining images to generate a new fastener in accordance with one or more embodiments.

FIG. 5A shows an example set of properties of fastener designs in accordance with one or more embodiments.

FIG. 5B shows an example set of properties of fastener designs in accordance with one or more embodiments.

FIG. 5C shows an example set of properties of fastener designs in accordance with one or more embodiments.

FIG. 6A shows a computing system in accordance with one or more embodiments of the technology.

FIG. 6B shows a computing system in accordance with one or more embodiments of the technology.

### DETAILED DESCRIPTION

Specific embodiments of the technology will now be described in detail with reference to the accompanying figures. Like elements in the various figures are denoted by like reference numerals for consistency.

In the following detailed description of embodiments of the technology, numerous specific details are set forth in order to provide a more thorough understanding of the technology. However, it will be apparent to one of ordinary skill in the art that the technology may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments are directed to a computer selecting a fastener and/or generating a design of a fastener. The computer extracts a variety of features from an initial set of fastener parameter values for a fastener. The computer operates a neural network model to query a fastener description repository and identify a set of possible matching fasteners. By way of an example, if the set of fastener parameter values is a submitted image of a fastener, the neural network model may be a convolutional neural network (CNN) that classifies the submitted image based on the stored images of fasteners. If the set of fastener parameter values are property values of a fastener, a recurrent neural network (RNN) may determine a set of estimated values. The combination of the fastener values submitted by the user and the estimated values may be used to search the fastener description repository and find possible matching fasteners. One or more embodiments may generate a new fastener design. In contrast to computer aided design in which a human ultimately generates the design with the help of a computer, the neural network model may be configured to combine fastener designs and generate a new fastener design.

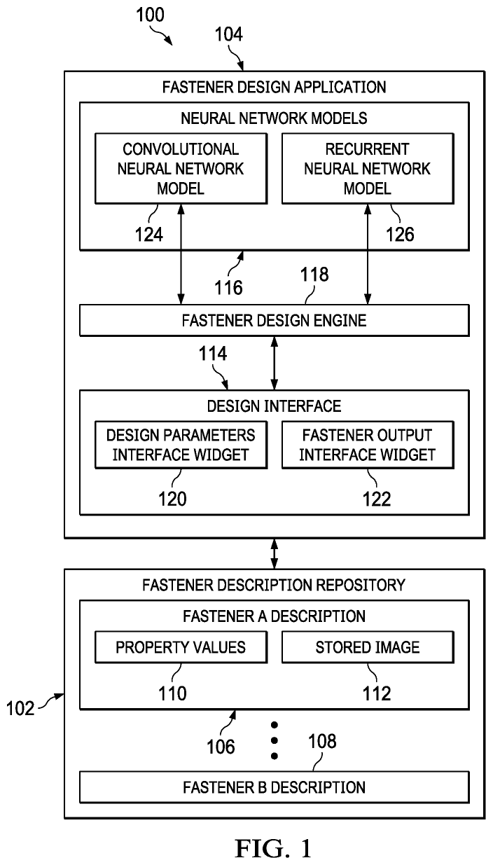

FIG. 1 shows a diagram of a system (100) in accordance with one or more embodiments. As shown in FIG. 1, the system (100) includes a fastener description repository (102) and a fastener design application (104). These components are described below.

The fastener description repository (102) includes multiple fastener descriptions (e.g., fastener A description (106), fastener B description (108)). The fastener description repository (102) may include one or more public storage repositories of fastener descriptions and/or one or more proprietary storage repositories. As such, the fastener description repository (102) may physically include any type of storage unit and/or device (e.g., a file system, a database, a collection of tables, or any other storage mechanism) for storing data.

A fastener description (e.g., fastener A description (106), fastener B description (108)) is a description of a fastener. A fastener is a hardware device that mechanically joins two or more physical objects together. The fastener includes at least one distinct hardware part from the physical objects that are connected by the fastener. Different types of fasteners exist, such as the various types of nails, screws, hook and eye, staples, rivets, latches, pins, clutch, clips or other such devices. The fastener may include a hinge, a spring, dowels, or other devices when used to join at least two physical objects.

Continuing with the fastener description (e.g., fastener A description (106), fastener B description (108)), each fastener description has property values (e.g., property values (110)) and, optionally, a stored image (e.g., stored image (112)). The property values are the values of the properties of the fastener. One or more of the properties forms a unique identifier of the fastener and is related in storage to the remaining property values (110) and the stored image (112). The properties include geometric properties, composition properties, coatings, mechanical properties, and other properties of the fastener.

Geometric properties describing the shape of the fastener. For example, for a screw, the geometric properties include thread length, protrusion, thickness, width, overall length, thickness, etc. Mechanical properties may include tensile strength, shear strength, load, and other such properties. Composition properties are the one or more materials of which the fastener is composed. Coatings may include a description of protective layers around the fastener.

Continuing with FIG. 1, the stored image (112) is at least one image of the fastener. The stored image (112) may be from a single perspective or multiple perspectives. The stored image (112) may be an image of a computer generated model or a picture of a physical fastener.

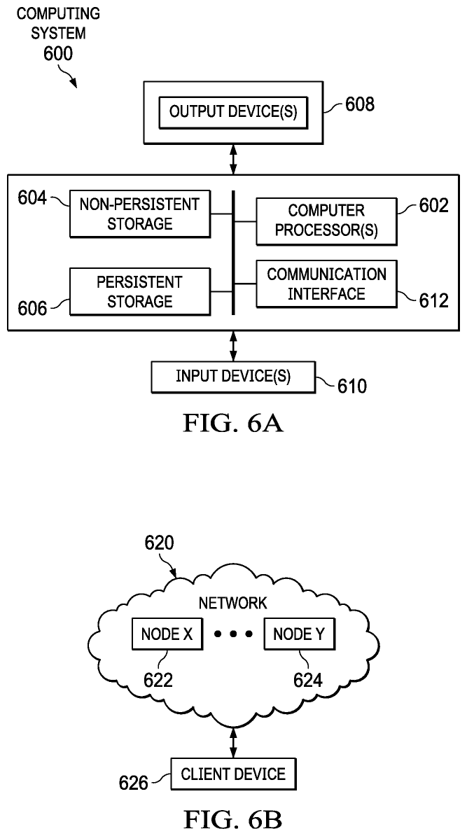

The fastener description repository (102) is connected to a fastener design application (104). The fastener design application (104) is a software application configured to execute on a computing system, such as the computing system described below with reference to FIG. 6A and FIG. 6B. The execution of the software application improves the operation of the computing system by causing the computing system to select and/or generate a fastener based on detecting the type of fastener that a human user needs when the human user can only provide partial information.

The fastener design application (104) includes a design interface (114), neural network models (116), and a fastener design engine (118). The design interface (114) includes design parameters interface widgets (120) and fastener output interface widgets (122). The design parameter interface widgets (120) are graphical user interface widgets (e.g., one or more text boxes, drop down boxes, check boxes, upload widgets or any other GUI widget) to receive a set of design parameter values. The set of design parameter values may include one or more values of design parameters. Design parameter values describe matching designs of a describe properties of matching fasteners. By way of some examples, one or more of the design parameter values may be one or more of the following: a submitted image of a fastener, a property value of a matching fastener, a range of property values (110) of a matching fastener, an environment in which a matching fastener will be used (e.g., surrounding materials), or any combination thereof.

Fastener output interface widgets (122) are graphical user interface widgets that present matching fasteners and/or possible matching fasteners. The fastener output interface widgets (122) may further include interface widgets for the user to select one or more possible matching fasteners and request creation of a new fastener design.

The neural network models (116) are models to detect and/or generate matching fasteners when the user may only provide partial information. The neural network models (116) may include a CNN model (124) and/or a RNN model (126). In one or more embodiments, the CNN model (124) is a neural network model that is configured to classify images. The CNN model (124) includes an input layer, output layer, and one or more hidden layers. Various CNN implementations may be used. For example purposes only, the CNN model (124) may be implemented as an AlexNet network described in Alex Krizhevsky, et al., “ImageNet classification with deep convolutional neural networks.” Communications of the ACM. 60 (6): 84-90. doi:10.1145/3065386 (May 24, 2017). As another example, the CNN model (124) may be a VGG network described in K. Simonyan, et al., “Very Deep Convolutional Networks for Large-Scale Image Recognition,” International Conference on Learning Representations, 2015.

The RNN model (126) is a neural network model that is configured to determine estimated parameter values at least from the set of submitted parameter values. The RNN model (126) may operate concurrently with the CNN model (124). As another example, the RNN model (126) may use an output of the CNN model (124). In one or more embodiments, the RNN model (126) includes a long short term memory (LSTM) model. The LSTM model is trained using supervised learning to minimize the cross-entropy between model outputs and one hot encoded targets. The one hot encoded targets are particular identifiers of fasteners. The model outputs are fasteners that match a training set of input parameter values to the model.

The fastener design engine (118) is configured to orchestrate selection and/or design of a fastener. The fastener design engine (118) is configured to communicate with the fastener description repository (102), the design interface (114) and the neural network models (116).

While FIG. 1 shows a configuration of components, other configurations may be used without departing from the scope of the technology. For example, various components may be combined to create a single component. As another example, the functionality performed by a single component may be performed by two or more components.

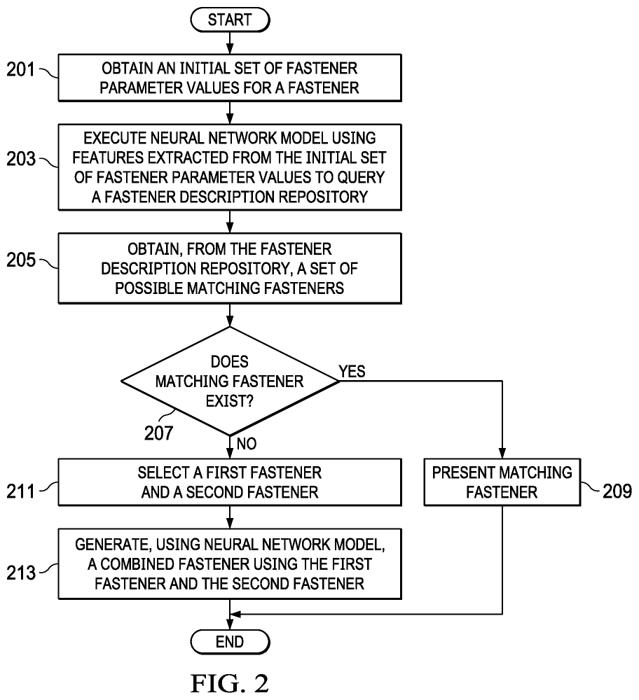

FIG. 2 shows a flowchart in accordance with one or more embodiments. While the various steps in this flowchart are presented and described sequentially, one of ordinary skill will appreciate that some or all of the steps may be executed in different orders, may be combined or omitted, and some or all of the steps may be executed in parallel. Furthermore, the steps may be performed actively or passively. For example, some steps may be performed using polling or be interrupt driven in accordance with one or more embodiments of the technology. By way of an example, determination steps may not require a processor to process an instruction unless an interrupt is received to signify that condition exists in accordance with one or more embodiments of the technology. As another example, determination steps may be performed by performing a test, such as checking a data value to test whether the data value is consistent with the tested condition in accordance with one or more embodiments of the technology.

In Step 201, an initial set of fastener parameter values for a fastener is obtained. In one or more embodiments, the design interface receives one or more design parameters in the design parameter interface widgets. The initial set of design parameter values are incomplete. For example, the initial set of design parameter values may be a submitted image of a fastener. For example, a user may identify a picture of a fastener and want the same or similar fastener. The picture is a partial set because the picture does not include material properties and may not include all perspectives. Similarly, a user may submit a partial set of parameter values that may not include key compositional and/or geometric properties, such as tread width, grove, flange thickness, type of coating, or other properties.

In Step 203, a neural network model is executed using features extracted from the initial set of fastener parameter values to query a fastener description repository. In one or more embodiments, features are extracted from the initial set of fastener parameter values. If the initial set of parameter values is a submitted image of a fastener, then the submitted image is input into the CNN model. Accordingly, the CNN is executed.

If the initial set of fastener parameter values are alphanumeric values specifying one or more properties of the values, a first set of features may be extracted from the initial set of fastener parameter values. A second set of features form a context of the fastener. The context is extracted from a design tool that designs the environment of the fastener. The context may include the environment of the fastener, such as the composition of the materials, the use of objects joined by the fastener, and other context information. A feature vector may be generated from the first set of features and the second set of features. The feature vector transforms the features into vector space. Various mappings may be used to transform the features into vector space. The execution of the RNN model may be used to generate a revised set of parameter values. The revised set of parameter values include a set of estimated parameters that are output from the RNN model. Specifically, the RNN model may be trained to map the extracted features to a set of estimated parameter values.

In Step 205, a set of possible matching fasteners is obtained from a fastener description repository. For example, the set of estimated parameter values may be used as input to a query to the fastener description repository. The set of possible matching fasteners is a set of fasteners that match the set of estimated parameter values. Namely, for each value in the set of estimated parameter values, the matching fastener has a property value within a range of the estimated parameter value. The range may be defined by thresholds. Further, multiple possible matching fasteners may be returned.

With a submitted image of a fastener, CNN model is trained to classify the fastener in the submitted image to identify one or more matching fasteners. Specifically, each image of a fastener in the fastener description repository may be an individual class. The CNN model is configured to classify the submitted image of the fastener by outputting a probability value that the classifier in the submitted image belongs to a particular class. The CNN may output multiple such probability and classes.

In Step 207, a determination is made whether a matching fastener exists. If both a set of property values and a submitted image are input, then both the RNN model and the CNN model are executed. A match may be determined to exist when the output of the RNN model and the CNN model return the same identifier of a fastener from the fastener description repository.

As another example, the set of possible matching fasteners may be presented to a user. The user may select a fastener from the set of possible matching fasteners.

In Step 209, if a matching fastener exists, the matching fastener is presented in one or more embodiments. For example, the matching fastener may be added to a design specification and the design tool. As another example, the matching fastener may be displayed.

If a determination is made that a matching fastener does not exist, the flow may proceed to Step 211. In Step 211, a first fastener and a second fastener are selected. In some embodiments, a user may select to merge two fastener designs to create a single fastener design. The merging may be performed using the neural network model.

In Step 213, using a neural network model, a combined fastener is generated using the first fastener and the second fastener. Both the CNN model and the RNN model may be used to create a merged fastener design. The CNN model may merge an image of the first fastener with an image of the second fastener to create a single new image of a fastener. The RNN model may be used to merge the properties of the first fastener with the properties of the second fastener to create estimated properties of the new fastener design. Convergence exists if the image of the new design of the fastener matches the geometric properties of the new design of the fastener. In such a scenario, the fastener design may be presented or otherwise outputted to a user. The user may then decide whether to accept or reject the new design. If the user rejects the new design, the user may tweak the set of fastener parameters, or the image, and the process may repeat.

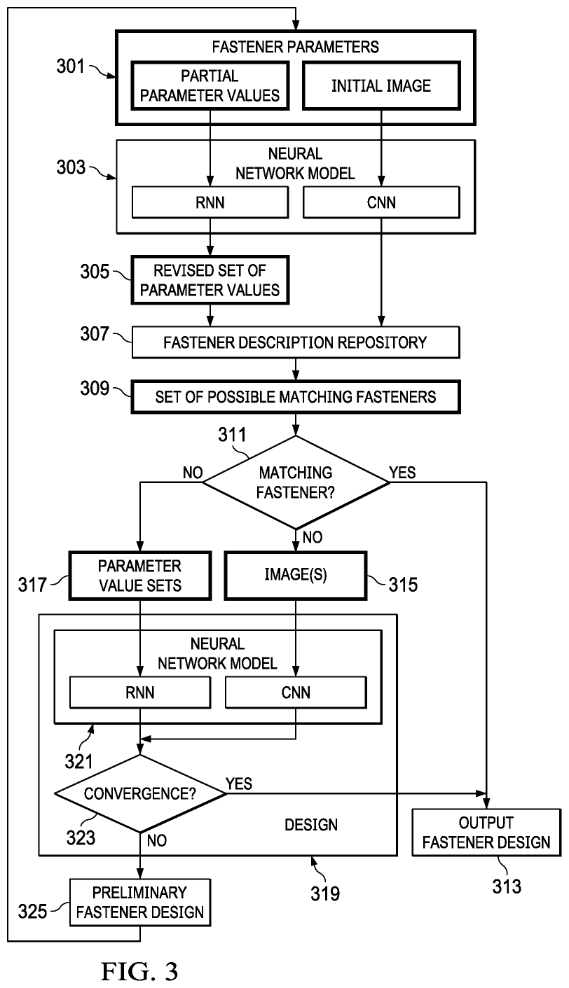

FIG. 3 shows an example flow diagram in accordance with one or more embodiments. In Block 301, an initial set of fastener parameter values are received. The initial set may include partial parameter values and/or an initial image. The initial set of fastener parameter values are input to a neural network model in Block 303. Partial parameter values are input into the RNN model and an initial image is input into the CNN model. The RNN model generates a revised set of parameter values that include the partial parameter values and the estimated set of parameter values in Block 305.

The revised set of parameter values and the CNN model are used in the fastener description repository in Block 307. The result of the revised set of parameter values and the use of the CNN model is a set of possible matching fasteners in Block 309. If a matching fastener is found in Block 311, the fastener design is outputted in Block 313.

If a matching fastener is not outputted, the flow may proceed to a design phase in Block 319. The design phase may include the same neural network models (Block 321) as Block 303. Specifically, the CNN model may use, as input, two or more images (Block 315) of fasteners from the set of possible matching fasteners to generate an output fastener design. The RNN model may use fastener property value sets (Block 317) of two or more fasteners in the set of possible matching fasteners to create the output fastener design. If convergence exists at Block 323 of the output fastener designs of the RNN model and the CNN model then the output fastener design is presented in Block 313. If convergence does not exist, the output fastener design of the RNN model and the CNN model is a preliminary fastener design in Block 325 that may be presented and adjusted by a user. The process may repeat with the further adjusted fastener design in Block 301.

Through the process described in FIG. 2 and FIG. 3, a computer system may detect a matching fastener when only partial information exists. Specifically, using the neural network models, the computer system can predict an intent of a matching fastener. Further, by being able to combine fasteners, the computer system is trained to generate new fastener designs automatically. Combined fasteners create a design that may solve more than one use case. Thus, a combined fastener design reduces resource usage.

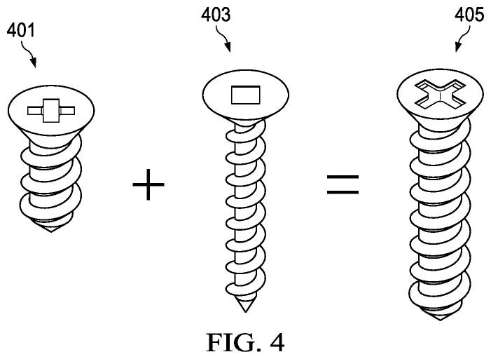

FIG. 4 shows an example of a combined fastener design using a CNN model on two fastener images. In FIG. 4, a first screw (401) is merged with a second screw (403) to create a new screw (405). The new screw (405) may have some properties of the first screw (401) (e.g., Philips head) and some properties of the second screw (403) (e.g., thread gauge). Further, some of the properties, such as flange thickness, may be merged.

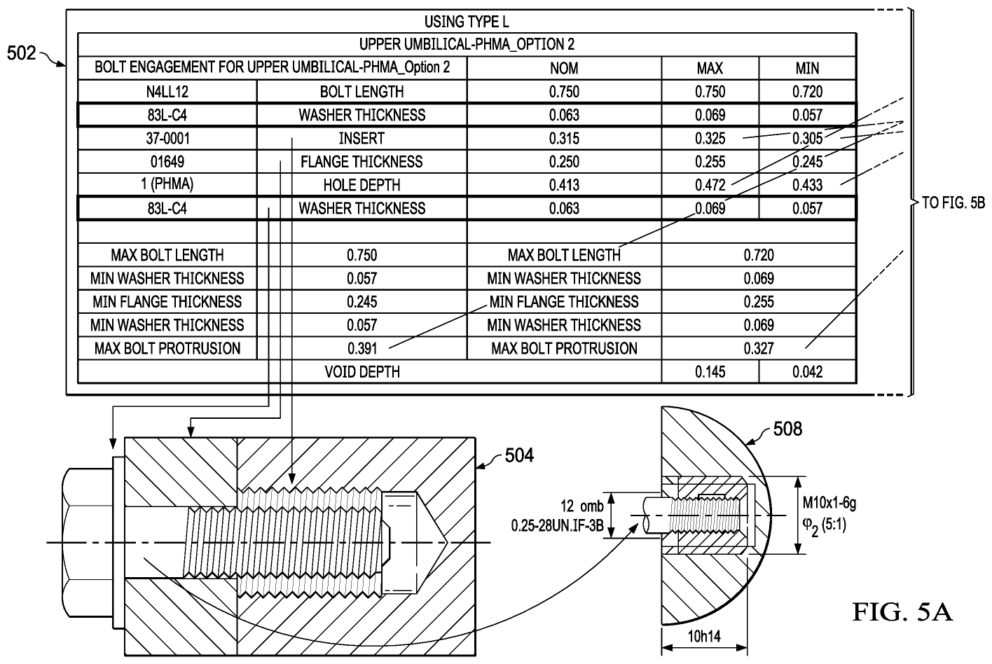

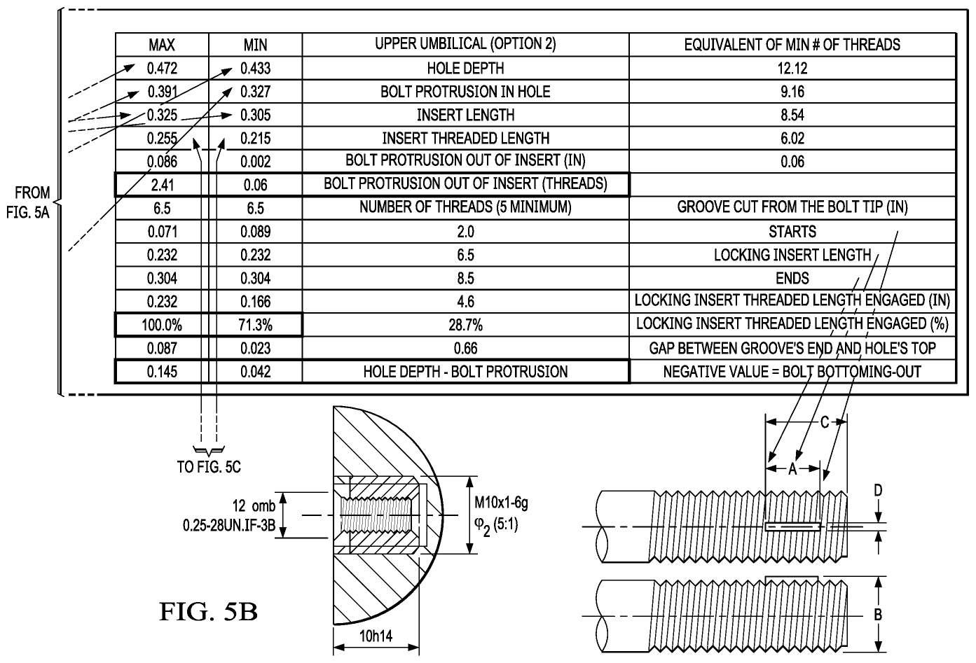

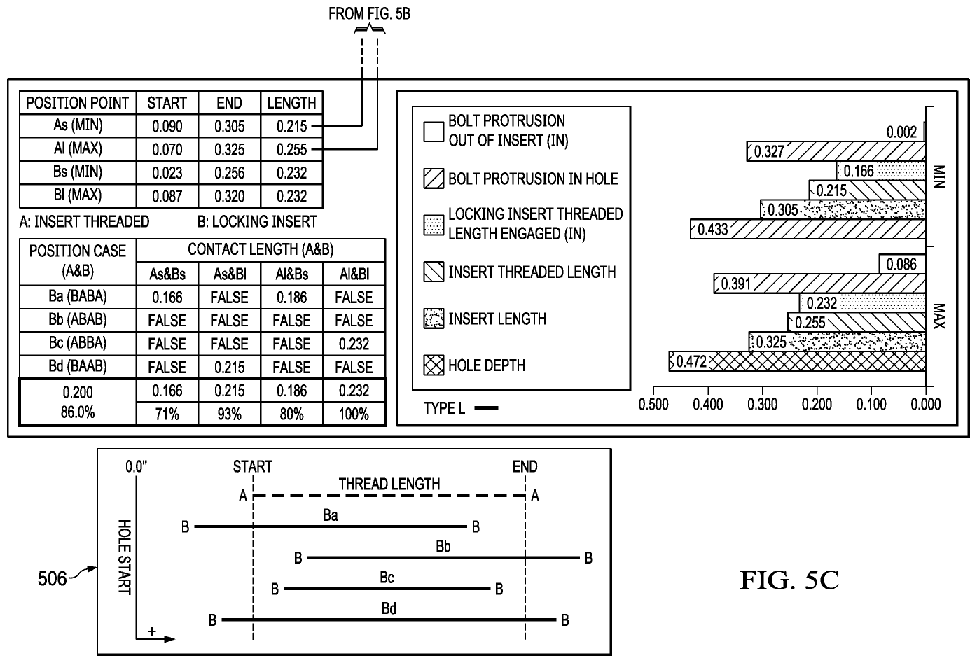

FIG. 5A, FIG. 5B, and FIG. 5C show an example set of properties of fastener designs in accordance with one or more embodiments. One or more embodiments are configured to determine, using a neural network model, additional property values from a partial set of property values. A table (502) references portions of a fastener (504) as shown by the lines. A fastener may have a start and end of a thread length as shown in chart (506). A matching fastener matches a hole (508) that is based on the objects being combined. Namely, a fastener with too little thread in the hole does not have enough hold ability whereas a fastener that is too long can break the material. Similarly, in some cases, the fastener (504) should be flush with the hole (508), while in other cases, the fastener (504) should have a protrusion out of the hole (508). The RNN model includes functionality to fill in the missing parameters that may not be provided by a user.

Embodiments of the technology may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 6A, the computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), and numerous other elements and functionalities that implement the features and elements of the disclosure.

The computer processor(s) (602) may be an integrated circuit for processing instructions. For example, the computer processor(s) (602) may be one or more cores or micro-cores of a processor. The computing system (600) may also include one or more input devices (610), such as a touchscreen, keyboard, mouse, microphone, touchpad, electronic pen, or any other type of input device.

The communication interface (612) may include an integrated circuit for connecting the computing system (600) to a network (not shown) (e.g., a local area network (LAN), a wide area network (WAN) such as the Internet, a mobile network, or any other type of network) and/or to another device, such as another computing device.

Further, the computing system (600) may include one or more output devices (608), such as a screen (e.g., a liquid crystal display (LCD), a plasma display, a touchscreen, a cathode ray tube (CRT) monitor, a projector, or other display device), a printer, external storage, or any other output device. One or more of the output devices (608) may be the same or different from the input device(s) (610). The input and output device(s) (610 and 608) may be locally or remotely connected to the computer processor(s) (602), non-persistent storage (604), and persistent storage (606). Many different types of computing systems exist, and the aforementioned input and output device(s) (610 and 608) may take other forms.

Software instructions in the form of computer readable program code to perform embodiments of the technology may be stored, in whole or in part, temporarily or permanently, on a non-transitory computer readable medium such as a CD, a DVD, a storage device, a diskette, a tape, flash memory, physical memory, or any other computer readable storage medium. Specifically, the software instructions may correspond to computer readable program code that, when executed by a processor(s), is configured to perform one or more embodiments of the technology.

The computing system (600) in FIG. 6A may be connected to or be a part of a network. For example, as shown in FIG. 6B, the network (620) may include multiple nodes (e.g., node X (622), node Y (624)). Each node may correspond to a computing system, such as the computing system shown in FIG. 6A, or a group of nodes combined may correspond to the computing system shown in FIG. 6A. By way of an example, embodiments of the technology may be implemented on a node of a distributed system that is connected to other nodes. By way of another example, embodiments of the technology may be implemented on a distributed computing system having multiple nodes, where each portion of the technology may be located on a different node within the distributed computing system. Further, one or more elements of the aforementioned computing system (600) may be located at a remote location and connected to the other elements over a network.

Although not shown in FIG. 6B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (622), node Y (624)) in the network (620) may be configured to provide services for a client device (626). For example, the nodes may be part of a cloud computing system. The nodes may include functionality to receive requests from the client device (626) and transmit responses to the client device (626). The client device (626) may be a computing system, such as the computing system shown in FIG. 6A. Further, the client device (626) may include and/or perform all or a portion of one or more embodiments of the technology.

The computing system or group of computing systems described in FIGS. 6A and 6B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the technology. The processes may be part of the same or different application and may execute on the same or different computing system.

Rather than or in addition to sharing data between processes, the computing system performing one or more embodiments of the technology may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL link. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the technology, may extract one or more data items from the obtained data. For example, the extraction may be performed as follows by the computing system in FIG. 6A. First, the organizing pattern (e.g., grammar, schema, layout) of the data is determined, which may be based on one or more of the following: position (e.g., bit or column position, Nth token in a data stream, etc.), property (where the property is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For property/value-based data, the token(s) and/or node(s) associated with the property(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 6A, while performing one or more embodiments of the technology, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A—B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the technology, A and B may be vectors, and comparing A with B requires comparing the first element of vector A with the first element of vector B, the second element of vector A with the second element of vector B, etc. In one or more embodiments, if A and B are strings, the binary values of the strings may be compared.

The computing system in FIG. 6A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, data containers (database, table, record, column, view, etc.), identifiers, conditions (comparison operators), functions (e.g. join, full join, count, average, etc.), sorts (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 6A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data property within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 6A and the nodes and/or client device in FIG. 6B. Other functions may be performed using one or more embodiments of the technology.

While the technology has been described with respect to a limited number of embodiments, those skilled in the art, having benefit of this disclosure, will appreciate that other embodiments can be devised which do not depart from the scope of the technology as disclosed herein. Accordingly, the scope of the technology should be limited only by the attached claims.

What is claimed is:

1. A method comprising:
obtaining an initial set of fastener parameter values for a fastener;
executing a neural network model using features extracted at least from the initial set of fastener parameter values to query a fastener description repository;
obtaining, from the fastener description repository, a set of possible matching fasteners; and
presenting a matching fastener when the matching fastener is in the set of possible matching fasteners.

2. The method of claim 1, wherein the initial set of fastener parameter values comprises a plurality of partial parameter values, wherein the neural network model comprises a recurrent neural network (RNN) model, and wherein executing the RNN model adds an estimated set of parameter values to the initial set of fastener parameter values to create a revised set of parameter values; and wherein the method further comprises:
querying the fastener description repository with the revised set of parameter values to obtain the set of possible matching fasteners.

3. The method of claim 2, wherein executing the RNN model comprises:
extracting a first set of features from the initial set of fastener parameter values; and
extracting a second set of features from a context of the fastener, the context extracted from a design tool that designs an environment of the fastener; and
executing the RNN model on the first set of features and the second set of features.

4. The method of claim 1, wherein the initial set of fastener parameter values comprises a submitted image of the fastener, wherein the neural network model is a convolutional neural network (CNN) model, and wherein executing the CNN model comprises classifying the submitted image based on a plurality of stored images in the fastener description repository.

5. The method of claim 1,
wherein the initial set of fastener parameter values comprises a plurality of partial parameter values and a submitted image of the fastener,
wherein the neural network model comprises a RNN model and a CNN model,
wherein executing the RNN model adds an estimated set of parameter values to the initial set of fastener parameter values to create a revised set of parameter values for obtaining a first set of possible matching fasteners,
wherein executing the CNN model comprises classifying the submitted image based on a plurality of stored images in the fastener description repository to obtain a second set of possible matching fasteners, and
wherein the method further comprises comparing the first set of possible matching fasteners to the second set of possible matching fasteners to determine whether the matching fastener exists.

6. The method of claim 5, wherein comparing the first set of possible matching fasteners to the second set of possible matching fasteners comprises comparing alphanumeric identifiers assigned to the first set of possible matching fasteners and the second set of possible matching fasteners.

7. The method of claim 1, further comprising:
determining that the matching fastener does not exist;
selecting a first fastener and a second fastener;
generating, using the neural network model, fastener design based on the first fastener and the second fastener.

8. The method of claim 7, wherein generating the fastener design comprises retraining a RNN model using a first set of parameter values from the first fastener and a second set of parameter values from the second fastener to create a revised fastener that combines the first fastener and the second fastener.

9. The method of claim 7, wherein generating the fastener design comprises executing a CNN model using a first image of the first fastener and a second image of the second fastener to create a combined image of the first fastener and the second fastener.

10. The method of claim 9, wherein generating the fastener design comprises retraining a RNN model using a first set of parameter values from the first fastener and a second set of parameter values from the second fastener to create a revised fastener that combines the first fastener and the second fastener; and wherein the method further comprises:
comparing the revised fastener with the combined image to detect convergence.

11. A system comprising:
a fastener description repository comprising a plurality of fastener descriptions; and
a computer processor configured to perform operations, the operations comprising:
obtaining an initial set of fastener parameter values for a fastener;
executing a neural network model using features extracted at least from the initial set of fastener parameter values to query the fastener description repository;
obtaining, from the fastener description repository, a set of possible matching fasteners; and
presenting a matching fastener when the matching fastener is in the set of possible matching fasteners.

12. The system of claim 11, wherein the initial set of fastener parameter values comprises a plurality of partial parameter values, wherein the neural network model comprises a recurrent neural network (RNN) model, and wherein executing the RNN model adds an estimated set of parameter values to the initial set of fastener parameter values to create a revised set of parameter values; and wherein the operations further comprise:
querying the fastener description repository with the revised set of parameter values to obtain the set of possible matching fasteners.

13. The system of claim 12, wherein executing the RNN model comprises:
extracting a first set of features from the initial set of fastener parameter values; and
extracting a second set of features from a context of the fastener, the context extracted from a design tool that designs an environment of the fastener; and
executing the RNN model on the first set of features and the second set of features.

14. The system of claim 11, wherein the initial set of fastener parameter values comprises a submitted image of the fastener, wherein the neural network model is a convolutional neural network (CNN) model, and wherein executing the CNN model comprises classifying the submitted image based on a plurality of stored images in the fastener description repository.

15. The system of claim 11,
wherein the initial set of fastener parameter values comprises a plurality of partial parameter values and a submitted image of the fastener,
wherein the neural network model comprises a RNN model and a CNN model,
wherein executing the RNN model adds an estimated set of parameter values to the initial set of fastener parameter values to create a revised set of parameter values for obtaining a first set of possible matching fasteners,
wherein executing the CNN model comprises classifying the submitted image based on a plurality of stored images in the fastener description repository to obtain a second set of possible matching fasteners, and
wherein the operations further comprise comparing the first set of possible matching fasteners to the second set of possible matching fasteners to determine whether the matching fastener exists.

16. The system of claim 11, wherein the operations further comprise:
determining that the matching fastener does not exist;
selecting a first fastener and a second fastener;
generating, using the neural network model, fastener design based on the first fastener and the second fastener.

17. The system of claim 16, wherein generating the fastener design comprises executing a CNN model using a first image of the first fastener and a second image of the second fastener to create a combined image of the first fastener and the second fastener.

18. The system of claim 17, wherein generating the fastener design comprises retraining a RNN model using a first set of parameter values from the first fastener and a second set of parameter values from the second fastener to create a revised fastener that combines the first fastener and the second fastener; and wherein the system further comprises:
comparing the revised fastener with the combined image to detect convergence.

19. A non-transitory computer readable medium comprising computer readable program code for causing a computer system to perform operations, the operations comprising:
obtaining an initial set of fastener parameter values for a fastener;
executing a neural network model using features extracted at least from the initial set of fastener parameter values to query a fastener description repository;
obtaining, from the fastener description repository, a set of possible matching fasteners; and
presenting a matching fastener when the matching fastener is in the set of possible matching fasteners.

20. The non-transitory computer readable medium of claim 19, wherein the operations further comprise:
determining that the matching fastener does not exist;
selecting a first fastener and a second fastener;
generating, using the neural network model, fastener design based on the first fastener and the second fastener.
